(19) United States
(12) Patent Application Publication
(10) Pub. No.: US 2008/0007015 A1
(43) Pub. Date: Jan. 10, 2008

(54) Stepping wheels truck

(76) Inventor: Amyrbiy Bidzhiev, Karachaevsk (RU)

Correspondence Address: Amyrbiy Bidzhiev, 9 Burgh Ave., Clifton, NJ, 07011, US

(21) Appl. No.: 11/480,626

(22) Filed: Jul. 5, 2006

(51) Int. Cl. B62B 5/02

(52) U.S. Cl. 280/5.26

(57) ABSTRACT

The Stepping Wheels Concept is the conception of dividing the existing wheel into several smaller wheels, which are peripheral to the main axis, in this case four of them which have their own rotation. Peripheral wheels are connected with each other by the “shoulders”. The point of intersection of the shoulders is the central axis of the wheel.

The Stepping Wheels Hand Truck and its modifications are build on the basis of that concept and mostly designed for moving heavy items and cargo upstairs and downstairs in the buildings without elevators—mostly two or three leveled buildings and can be used by moving professionals as part of their equipment.

All the inventions come from some needs to improve something, some functions, some devices, or to fulfill the lack of something, to do something easier, to avoid burdens, to satisfy necessities. Sometimes it comes from feeling that something is not perfect and you try to make it closer to perfection—this is my case, actually the whole world is not perfect, so the opportunities for discoveries and inventions are endless, but let's get to business.

I told before that my invention came from intention to make something closer to perfection, but it also comes from need to avoid burdens. When later I started thinking about it I revealed that it can be used as a general concept in many different areas and many different devices and mechanisms, and my point is that I would like to have patents for the general concept and for my first device as well, and also please consider that this device can also be done in different varieties, which I am going to describe you here, whether they deserve separate patents or not it is up to your jury, please inform me about that.

In 2004 I was working as a helper to one contractor who was doing hardwood floors in New Jersey. We were working mostly in private houses without elevators, usually it were 2-3 leveled buildings, and my job was to move very heavy sanding machines to second and third levels, it was very hard and inconvenient, we didn't have any devices for that and that seemed to me a big drawback of that job. I spoke to people, working in moving companies to know what they use to move heavy items upstairs and downstairs, and the answer always was “we use our hands”, and this situation seems to me completely backward,—this is how this idea came to me.

All the people in the world from time to time have this hard experience especially when moving from one place to another and not always can hire moving professionals and have to move heavy items upstairs and downstairs or when buying furniture or TVs and not always having elevators. For single women and senior people it becomes a real hardship and I want to change this situation forever. It can be used for domestic purposes and for commercial places as well: stores, warehouses production facilities etc.

The ancient people invented a unique device which benefited all the following generations up to nowadays which is a wheel. It is hard to imagine any area of civilization's life without it, but now it is time to reinvent it.

And this is how I call my invention—REINVENTING A WHEEL

Existing wheel is a unique and almost perfect device which requires more or less relatively smooth surface to be used on. It can not be used on very rough surfaces such as stairs or stony landscape, unless it has a big diameter which is not acceptable everywhere and we need to make it more compatible to all the areas of life to all the surfaces to be used on.

My idea is to divide the existing wheel into several parts 3, 4, 5, 6 or even more which are already small wheels and have its own axis and rotation and are the peripheral to the main axis and entire wheel. I call it multiaxis wheel or stepping wheel.

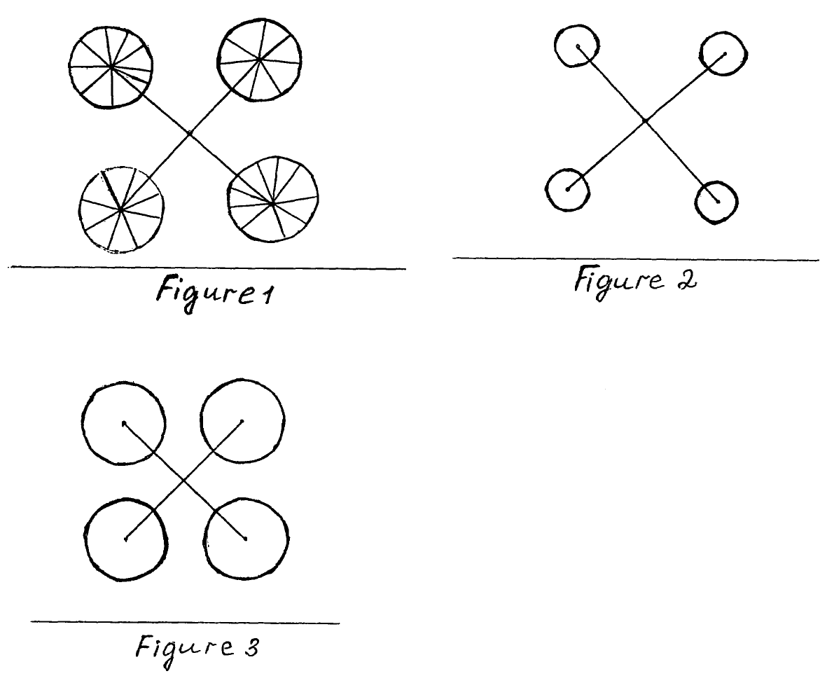

By the wisdom of God earth created round and rotating and God gave the idea of a wheel to the mankind as the analogy of his great wisdom. By other Gods great wisdom created the “sun system”, which has one central axis, which is the sun, and many other small axis of the planets on the periphery rotating around the sun and around their own small axis at the same time. My invention is the analogy of the “sun system” and I am sure it comes from God and I am sure it must have its place on the earth The main concept of the idea you can see on the page 1 of drawings—FIGS. 1, 2, 3 which are 4 small wheels which' axis located on the ends of the cross and point of intersection of that main cross is the main axis of the entire wheel. Parts of that cross from the intersection to the peripheral axis I would call them “shoulders”.

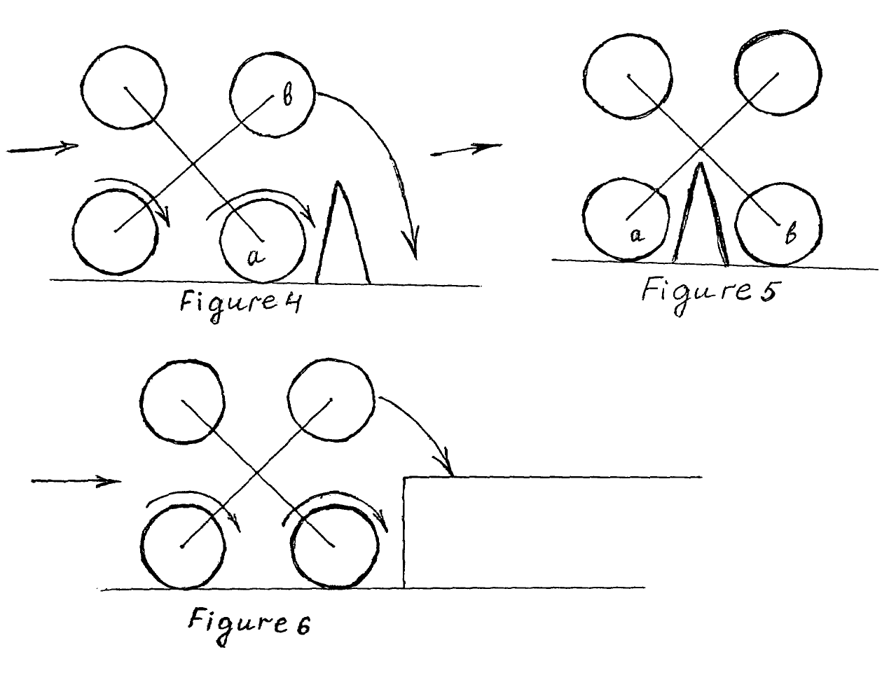

Once the vehicle or the hand truck with this type of wheel encounters with an obstacle (stone, border, hump, step, higher level surface) it just steps over it see FIGS. 4, 5 and 6 on the page 2 of drawings, arrows show direction of moving.

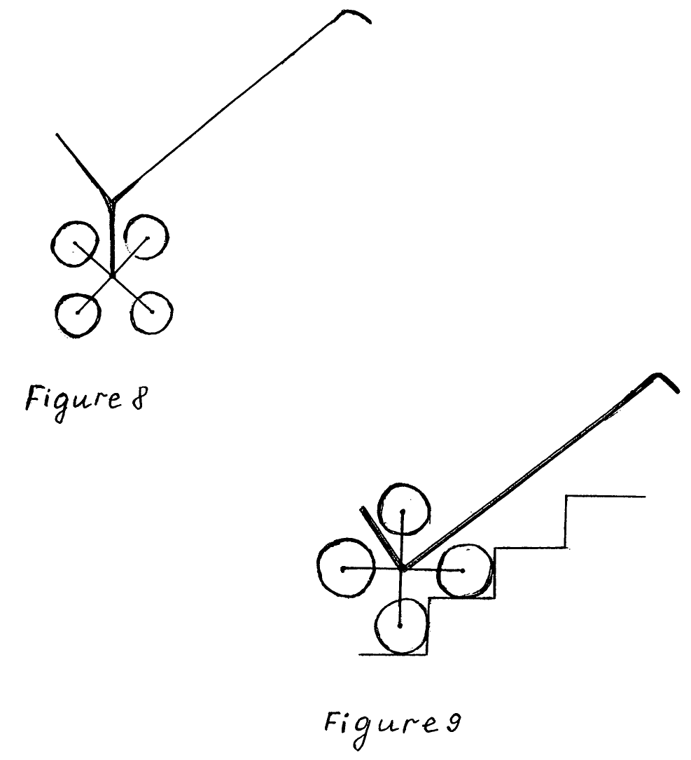

But the main idea is to use that type of hand trucks on the stairs, look how it behaves on a staircase. Look at the FIG. 7—every small wheel steps on its step, while the entire wheel is rotating.

Here is my first device—HAND TRUCK WITH MULTIAXIS WHEEL in this case this truck has two cross type multiaxis wheels; each of them has 4 peripheral smaller wheels. This is not final; this is the simplest variation of it. Look it is designed to move heavy items like furniture or TVs upstairs and downstairs or to ship cargo to commercial facilities with upper or lower storage premises. When using it with heavy items it is preferred to be in two persons—one from ahead and one from the back—(FIGS. 8 and 9)

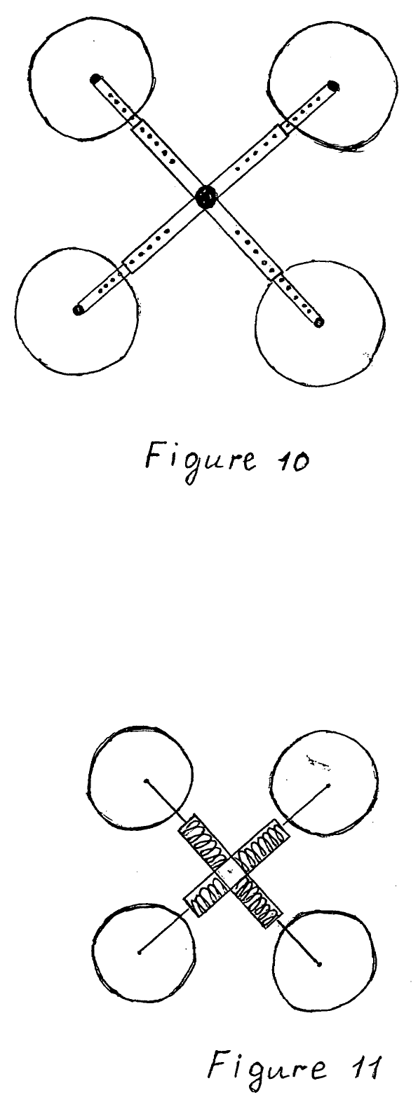

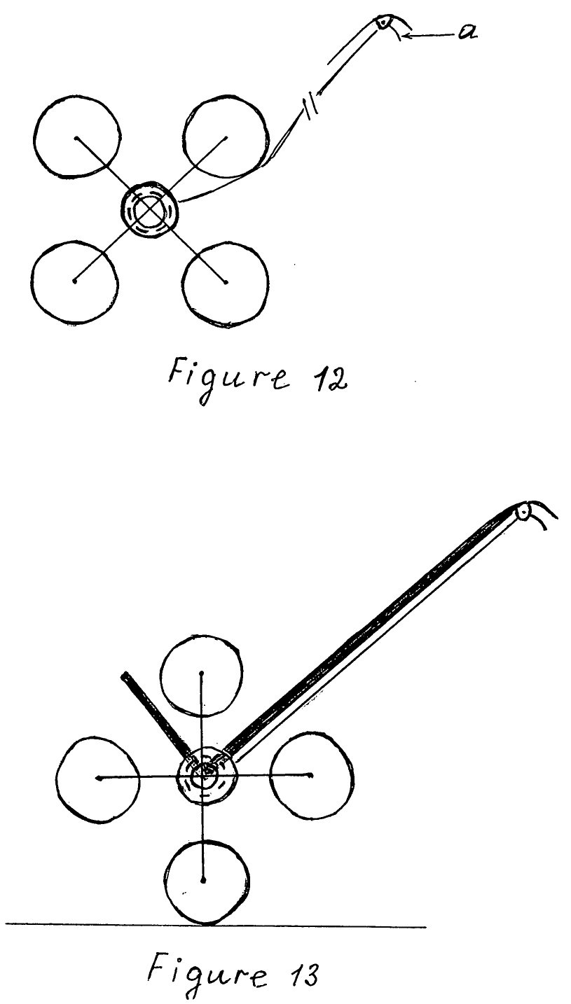

All the stairs in the whole world are designed and build according to average ergonomic sizes of human feet (except some special designs).The average ergonomic size of human feet are about the same in the whole world; so this truck can be used all over the world. But in case of any differences it is very easy to calculate the diameter of peripheral wheels and the length of shoulders an softness of tires and to adjust it to specific situation to make it move smooth, moreover the length of shoulders can be adjusted right on the spot, if to build them adjustable with holes and positioning sticks, (FIG. 10). Also to make it move smooth on the stairs—springs can be used on the shoulders (FIG. 11), in this case it will move very smooth on the stairs like a panther or leopard approaching his prey, both directions—upstairs and downstairs.

I already see your question—“what about smooth surfaces?”,—yes you are right, when moving on smooth surfaces this truck will use two peripheral minor wheels from each side and is going to experience hard friction when making right or left turns, but I told you—this is not final.

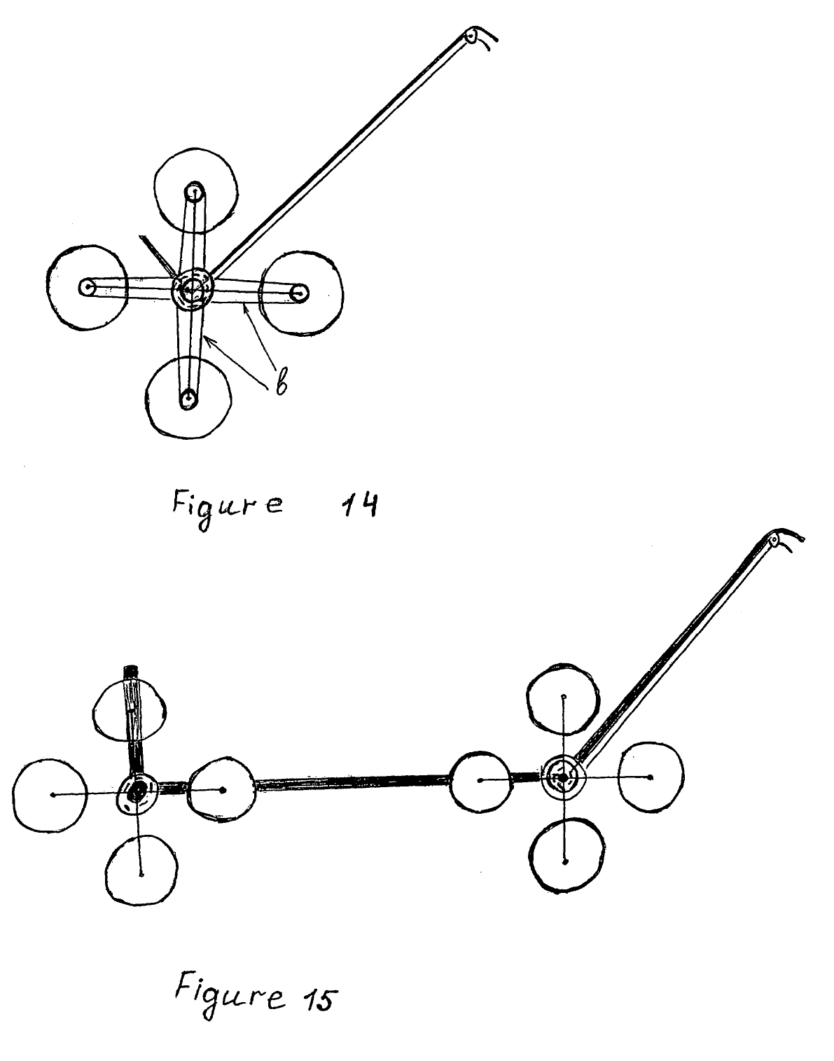

The solution is—to avoid hard friction when turning left or right,—is to make this truck move not on 4 peripheral wheels but on 2 peripheral wheels—one from each side, to make it possible I install the analogy of the torque converter system which is used on cars (or break system,—optional)(FIG. 12), which is mounted hard on the body of the truck and cooperates with the disk which is installed on the cross of either wheel and by squeezing and releasing the handle “a” (this function is variable )(FIG. 12) operator of the truck can allow or stuck rotation of the main central axis. By using this torque converter system it is easy to bring the crosses in proper position relatively the body of the truck and relatively ground, by putting the cross in vertical position we get only two peripheral wheels running on the ground,—so the problem of friction is solved (FIG. 13).

Next step is to make this truck operable for one person, when it is mostly used for moving heavy cargo, to make it possible I install electric engine with rechargeable battery, which is also operated from the button on the handle so when the operator reaches stairs or obstacle he releases or pushes handle (this function is variable) for the torque converter and turns on the engine and his efforts mostly directed for supporting and balancing cargo and little bit pulling when going upstairs; location of an engine is variable. When going downstairs operator of the truck can help himself by manipulating with the torque converter's handle, using its friction resistance for support to avoid heavy cargo pulling everything down and collapsing also vehicles break system can be used for that purposes instead of torque converter system.

So this is the basic modification of my hand truck, installing electric engine is optional. And this is my first device which I want to be patented Further I am going to describe you several another upgraded modifications of it, but getting upgraded they become more complicated and I believe: The more device is complicated, the less it is reliable and it is up to your jury whether it is worth another patent or not, please inform me about that.

Here we go: some people may require this truck to be able to move using engine power while moving on the smooth surfaces (ground, sidewalk, etc), to make it able to do that we must distribute rotation to peripheral small wheels and make it free at the central axis at the same time. It is possible by putting on the central axis a device working the same way as car transmission, connected with peripheral wheels with chains or belts “b” (FIG. 14). By switching the handle it is possible to switch rotation from the central axis to the peripheral wheels and back; and when it switches rotation to peripheral wheels it releases it on the main axis; and when it switches rotation from peripheral wheels to main axis it releases it on the peripheral wheels—this is important. So this was one of the modifications of the basic device.

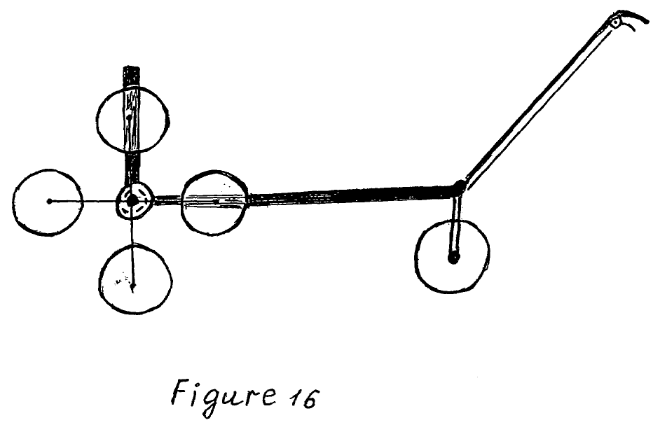

Another modification is the following: some people may require this truck to be more convenient to keep the balance while moving a heavy cargo and in areas where there is enough room the modification with 2 axis (4 stepping wheels) may be used with shift able handle (FIG. 15) or the same with one simple axis wheels from the operator's side (FIG. 16).

Dear Sirs take in consideration that I am not the best drawer, all drawings are schematic and do not reflect exact proportions and view of details this is my best ability to draw, please do not judge me hard for that. Exact sizes, proportions and details can be adjusted by a manufacturer and can vary from one manufacturer to another

Also I think the concept of Stepping Wheel has a good future in producing vehicles for disabled people; in producing the off-road vehicles and vehicles for exploring another planets.

And Dear Sirs—as you see the conception of the Stepping Wheel has many areas to be used in and I want to have a patent for Stepping Wheels Concept too, please let me know if it is possible, I rely on your honesty and good will and save you God.

### BRIEF DESCRIPTIONS OF THE PICTURES

FIGS. 1, 2, 3 show the basic idea of the stepping wheel concept in different variations and proportions. Length of shoulders and diameter of peripheral wheels may vary.

FIG. 4 shows stepping wheel in motion approaching an obstacle arrows show direction of movement, and direction of rotation of peripheral wheels, arrow, coming down from the peripheral wheel “b” shows the position of that wheel when going over an obstacle.

FIG. 5 is a consequence of FIG. 4 and shows the position of the wheel when overcoming an obstacle, it shows the consequent positions of peripheral wheels “a” and “b” when going over an obstacle.

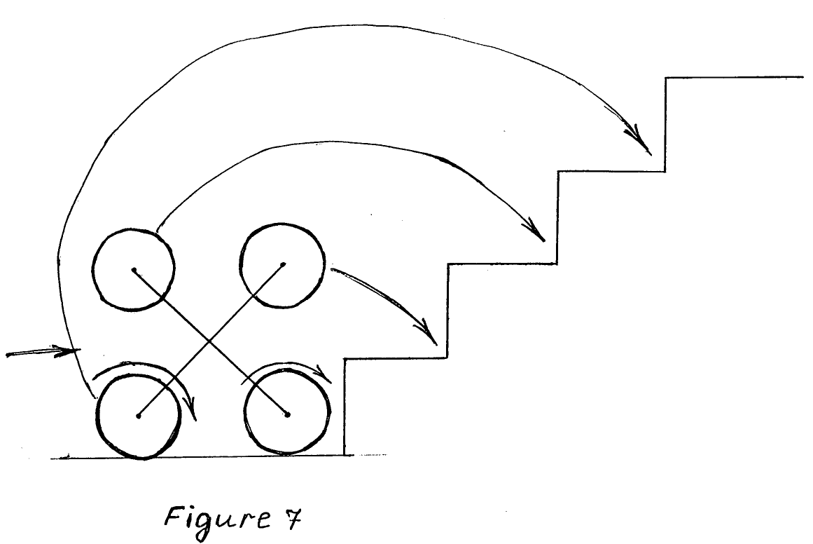

FIG. 6 shows the stepping wheel in motion, approaching a higher level surface, arrows show the direction of movement and direction of rotation of peripheral wheels, the arrow coming from upper right peripheral wheel shows its position in the moment of switching the surfaces.

FIG. 7 shows stepping wheel approaching a staircase; three lower short arrows show direction of movement and direction of rotation of peripheral wheels, three upper long arrows show the positions to step of each peripheral wheel, when moving upstairs.

FIG. 8 shows schematic view of one of the basic modifications of the Stepping Wheels truck.

FIG. 9 shows schematic view of another basic modification of the Stepping Wheels Truck in the moment of movement on a staircase either way upstairs or downstairs.

FIG. 10 shows the schematic view of stepping wheel with adjustable shoulders, the length of shoulders can be adjusted with holes and positioning sticks this is the basic idea about adjusting the length of shoulders.

FIG. 11 shows the schematic view of the stepping-wheel with springs, they allow it to move smooth; the strength of springs may vary, according to a manufacturer, they also may be done pneumatic.

FIG. 12 shows the schematic view of the stepping wheel with torque converter system, installed on the main axis and handle “a” for manipulating it.

FIG. 13 shows schematic view of the basic modification of Stepping Wheels Truck with torque converter system installed on it, which's main stepping wheel positioned by using the toque converter system, in order to move only on to peripheral wheels—one from each side, to avoid friction, when turning left and right. So the “cross” is positioned in vertical and horizontal (not diagonal) by manipulating the handle.

FIG. 14 shows the schematic view of the basic modification of the Stepping Wheels Truck, which has a system, which is the analogy of the car transmission, it can switch rotation from the main axis to peripheral wheels and back, using belts or chains “b”, the purpose of it is described in specification.

FIG. 15 shows the schematic view of the modification of the Stepping Wheels Truck with 2 main axis (4 stepping wheels) with shiftable handle

FIG. 16 shows the schematic view of the modification of the Stepping Wheels Truck with one simple wheel axis from the operator's side

1. What I claim as my invention is: Stepping Wheels Concept, which is presented in the FIGS. 1, 2 and 3

2. What I claim as my invention is: Stepping Wheels Truck, which is presented in the FIG. 13 and it's modifications which are presented in the FIGS. 8,9,14,15 and 16 and its modifications with additions, presented in FIGS. 10 and 11 and any of its modifications with an engine.
